(19) United States
(12) Patent Application Publication
(10) Pub. No.: US 2024/0230512 A1
(43) Pub. Date: Jul. 11, 2024

(54) TESTING APPARATUS

(71) Applicant: Nippon Telegraph and Telephone Corporation, Tokyo (JP)

(72) Inventors: Azusa Ishii, Tokyo (JP); Shingo Mineta, Tokyo (JP); Soichi Oka, Tokyo (JP)

(21) Appl. No.: 18/563,003

(22) PCT Filed: Jun. 8, 2021
(86) PCT No.: PCT/JP2021/021678

§ 371 Date: Nov. 21, 2023

(51) Int. Cl. G01N 17/00

(52) U.S. Cl. CPC G01N 17/004; G01N 17/002

(57) ABSTRACT

A test device includes a thermostatic tank, a heater, a rotary sample stage, a black panel thermometer, a light source, an in-tank thermometer, a sprayer, and a controller. The sprayer sprays water to samples placed on sample placement units of the rotary sample stage and the black panel thermometer. Mist droplets of mist sprayed by the sprayer are set in a range in which a decrease in temperature of the samples and the black panel thermometer irradiated with light is suppressed by spraying to the samples and the black panel thermometer.

### CROSS-REFERENCE TO RELATED APPLICATIONS

This application is a national phase entry of PCT Application No. PCT/JP2021/021678, filed on Jun. 8, 2021, which application is hereby incorporated herein by reference.

### TECHNICAL FIELD

The present invention relates to a test device for evaluating weathering.

### BACKGROUND

Accelerated weathering tests have been performed for durability evaluation of polymeric materials for use in outdoor environments. An accelerated weathering test is a test in which a sample is irradiated with light by an artificial light source light or sprayed with water so that deterioration by light or water is accelerated (Non Patent Literature 1). Repeating a test cycle including multiple steps including a step of only light irradiation and a step of simultaneously performing light irradiation and water spraying is common in the test.

In a device for performing the above-described test, a light source is arranged in the center of a test tank, and a rotary sample holder is arranged surrounding the light source (see Non Patent Literature 1, FIGS. 1 and 15). Furthermore, a radiometer and a black panel thermometer are installed in a part of the sample holder. The radiometer receives light from the light source and measures irradiance, and the light source is controlled such that the measured illuminance approaches a set value. In the black panel thermometer, a thermometer is attached to a stainless steel panel coated in black, simulating a black sample. A temperature measured by the black panel thermometer is referred to as a black panel temperature.

Furthermore, a test device includes a heater that heats the air inside the test tank, a humidifier that humidifies the air inside the test tank, and a blower that circulates the air inside the test tank. Circulating the air in the test tank by the blower contributes to making the temperature and humidity of the air uniform in the tank. The test device further includes an in-tank temperature measurement unit that measures the internal temperature of the test tank (in-tank temperature), and an in-tank humidity measurement unit that measures the internal humidity of the test tank (in-tank humidity). A control unit controls operation of the heater, the humidifier, and the blower such that the black panel temperature, the in-tank temperature, and the in-tank humidity approach set values. A water sprayer (sample spray) that sprays water to a sample may be further included in the test tank.

A test condition can be input from a test condition input unit, and the light irradiation intensity, the black panel temperature, the in-tank temperature, the in-tank humidity, the presence or absence of water spray, the time, the number of repetitions of the test cycle, and the like in each test step can be set.

As a light source of an accelerated weathering test device, a sunshine carbon arc lamp, an ultraviolet carbon arc lamp, a xenon arc lamp, a metal halide lamp, a mercury lamp, an ultraviolet fluorescent lamp, or the like is generally used (Non Patent Literature 1 and 2). Among them, xenon arc lamps having a spectral distribution similar to sunlight have been widely used in recent years. The light irradiation intensity of the light source can be set to any value, and is generally set such that light of 300 nm-400 nm is 40 W/m² to 180 W/m² in many cases. These light sources are generally cooled using cooling water and each have a lamp cooling mechanism for circulating the cooling water.

Furthermore, the cylindrical rotary sample holder includes a plurality of sample placement units on which samples to be tested are placed on the inner surface of the cylinder, and the samples are fitted and fixed to the frame-shaped sample placement units. The light source is arranged at a cylinder center of the frame-shaped sample holder, and the samples fixed to the plurality of respective sample placement units are arranged so as to surround the light source. In the test, the sample holder rotates at a constant speed around the light source, and light from the light source and water sprayed from the water sprayer uniformly hit each of the samples.

### CITATION LIST

### Non Patent Literature

Non Patent Literature 1: Shinji Iida, Hiromichi Takayanagi, Masami Yabe, “Introduction to Accelerated Weathering Test Methods”, Research on Coatings, No. 145, p. 22 to 37, 2006.
Non Patent Literature 2: Shinji Iida, Hiromichi Takayanagi, “Introduction to Accelerated Weathering Test Methods (Part 2)”, Research of Coatings, No. 146, 26 to 39, 2006.

### SUMMARY

### Technical Problem

In the accelerated weathering test, the temperature of the surfaces of the samples is increased by light irradiation, and accordingly, the surfaces of the samples are dried in a short time when water spraying is stopped while light irradiation is continued. For this reason, in a test in which light irradiation is performed in a state where the surfaces of the samples are wet, light irradiation is performed while water is sprayed. However, since the temperature of the surfaces of the samples is lowered by water spraying, the reaction rate of degradation in a light irradiation degradation test is lowered. Therefore, performing a light irradiation degradation test in a state where water is present is not easy.

For example, it is known that titanium dioxide widely used as a pigment for coatings and plastics decomposes water by photocatalytic action to generate hydroxy radicals, and the generated hydroxy radicals decompose a resin in the vicinity of titanium dioxide. In an accelerated weathering test of coatings or plastics in which titanium dioxide is used, water spraying is continued together with light irradiation, but in a test using the conventional accelerated weathering test device, it has been confirmed by the results of studies by the inventors that reproducing the decomposition of plastics or coatings in the vicinity of titanium dioxide that occurs outdoors is difficult.

As described above, in the conventional weathering test device, performing a test for accelerating a degradation reaction that progresses in the coexistence of water and light is difficult.

Embodiments of the present invention can solve the above issue, and an object of an embodiment of the present invention is to enable a test for accelerating a degradation reaction that progresses in the coexistence of water and light to be performed.

### Solution to Problem

A test device according to embodiments of the present invention includes a thermostatic tank, a heater that heats air inside the thermostatic tank, a humidifier that humidifies air inside the thermostatic tank, a rotary sample stage that is arranged inside the thermostatic tank, has a cylindrical shape, includes a plurality of sample placement units on which a sample to be tested is placed on an inner surface of a cylinder, and rotates around a cylinder, a black panel thermometer arranged on an inner surface of a cylinder of the rotary sample stage, a light source that is arranged at a rotation center of the rotary sample stage and irradiates the black panel thermometer and the sample placed on the sample placement units with light for a weathering test, an in-tank thermometer that measures a temperature in the thermostatic tank, a hygrometer that measures humidity in the thermostatic tank, a sprayer that sprays water to the sample placed on the sample placement units of the rotary sample stage, and a controller that controls a temperature in the thermostatic tank on the basis of a measurement result of the black panel thermometer and a measurement result of the in-tank thermometer such that a measurement result of the in-tank thermometer is a set sample temperature, in which mist droplets of mist sprayed by the sprayer are set in a range in which a decrease in temperature of the sample irradiated with the light is suppressed by spraying to the sample.

### Advantageous Effects of Embodiments of the Invention

As described above, according to embodiments of the present invention, mist droplets of mist sprayed by a sprayer that sprays water to a sample are set in a range in which a decrease in temperature of the sample irradiated with light is suppressed by spraying to the sample, so that a test for accelerating a degradation reaction that progresses in the coexistence of water and light can be performed.

### BRIEF DESCRIPTION OF THE DRAWINGS

FIG. 1A is a configuration diagram illustrating a configuration of a test device according to an embodiment of the present invention.

FIG. 1B is a configuration diagram illustrating a partial configuration of the test device according to the embodiment of the present invention.

### DETAILED DESCRIPTION OF ILLUSTRATIVE EMBODIMENTS

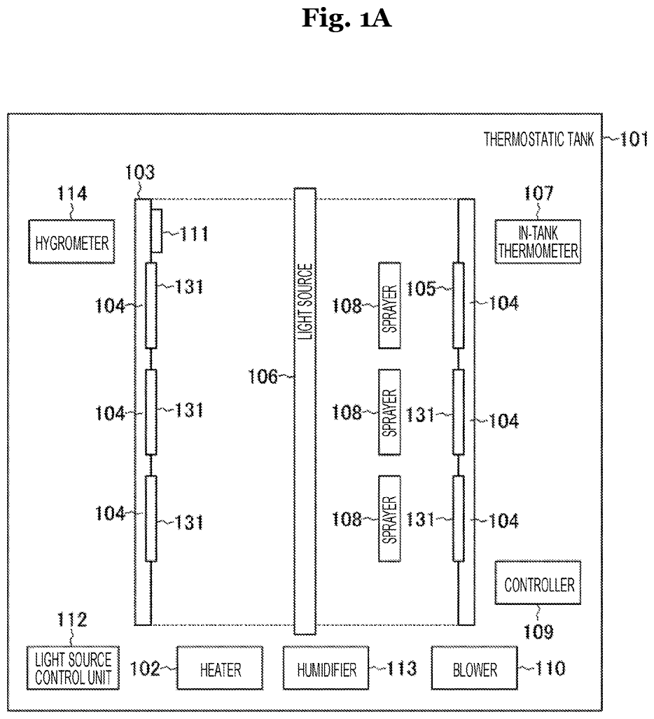

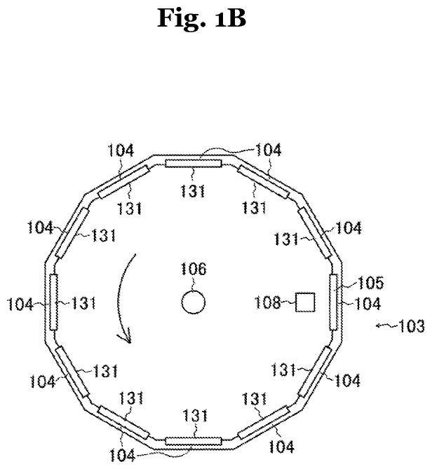

Hereinafter, a test device according to an embodiment of the present invention will be described with reference to FIGS. 1A and 1B. This test device is a device for performing an accelerated weathering test, and includes a thermostatic tank 101, a heater 102, a rotary sample stage 103, a black panel thermometer 105, a light source 106, an in-tank thermometer 107, a sprayer 108, and a controller 109.

The heater 102 heats the air inside the thermostatic tank 101. The rotary sample stage 103 is arranged inside the thermostatic tank 101 and has a cylindrical shape. For example, as illustrated in a top view of FIG. 1B, the rotary sample stage 103 is a cylinder having a dodecagon in a cross-sectional view, and has a dodecagonal prism outer shape. Furthermore, the rotary sample stage 103 includes a plurality of sample placement units 104 on which samples 131 to be tested are placed on the inner surface of the cylinder. For example, the samples 131 can be fixed by being fitted into the frames of the sample placement units 104. For example, the sample placement units 104 are provided for the respective sides of the dodecagonal prism of the rotary sample stage 103. Furthermore, a plurality of sample placement units 104 can be provided in the height direction of the rotary sample stage 103 for each of the sides of the dodecagonal prism of the rotary sample stage 103. FIG. 1A illustrates an example in which three sample placement units 104 are provided in the height direction of the rotary sample stage 103.

The rotary sample stage 103 is rotated around the cylinder by a rotation mechanism (not illustrated).

The black panel thermometer 105 is arranged on the inner surface of the cylinder of the rotary sample stage 103. The black panel thermometer 105 is arranged on one of the sample placement units 104. The black panel thermometer 105 includes a stainless steel plate coated in black and a temperature sensor provided on a surface of the stainless steel plate. The black panel thermometer 105 can further include a plastic (PVDF) heat insulating material attached to the back surface of the stainless steel plate coated in black, and the temperature sensor can be arranged between the stainless steel plate and the heat insulating material.

The light source 106 is arranged at the rotation center of the rotary sample stage 103, and irradiates the black panel thermometer 105 and the samples 131 placed on the sample placement units 104 with light for a weathering test. For the light source 106, the irradiation illuminance is measured by a radiometer 111, and the operation (output) is controlled by a light source control unit 112 using the measurement result.

For example, the light source 106 can be formed by a sunshine carbon arc lamp, an ultraviolet carbon arc lamp, a xenon arc lamp, a metal halide lamp, a mercury lamp, an ultraviolet fluorescent lamp, or the like (Non Patent Literature 1 and 2). For example, as the light source 106, a xenon arc lamp having a spectral distribution similar to sunlight has been widely used in recent years. The light irradiation intensity of the light source 106 can be set to any value, and is generally set such that light of 300 nm-400 nm is 40 W/m² to 180 W/m² in many cases. Although not illustrated, the light source 106 includes a lamp cooling mechanism that circulates cooling water, and can be cooled.

The in-tank thermometer 107 measures the temperature in the thermostatic tank 101. The sprayer 108 sprays water to the samples 131 placed on the sample placement units 104 of the rotary sample stage 103 and the black panel thermometer 105. Mist droplets of mist sprayed by the sprayer 108 are set in a range in which a decrease in temperature of the samples 131 and the black panel thermometer 105 irradiated with light is suppressed by spraying to the samples 131 and the black panel thermometer 105. By thin water films being formed on the surfaces of the samples 131 by the mist droplets of the sprayed mist being made small, a decrease in temperature of the surfaces of the samples 131 can be suppressed.

For example, the size of a droplet formed on an object to be sprayed (surface of the black panel thermometer 105) by spraying by the sprayer 108 is 1 μm to 99 μm. For example, the sprayer 108 can have a nozzle diameter of a nozzle for spraying of 0.3 mm. Note that the nozzle diameter of the nozzle used in the sprayer 108 can be less than 0.3 mm. By the nozzle diameter being reduced, the pressure at the time of spraying can be further increased, and a mist droplet having a smaller size can be obtained.

Furthermore, a plurality of sprayers 108 may be included in accordance with the positions of a plurality of sample placement units 104 arranged. The distance between the spray ports of the sprayers 108 and the sample placement units 104 is desirably 10 cm at the maximum. With this configuration, the amount of water sprayed from the sprayers 108 and attached to the surfaces of the samples 131 can be in a similar state for each of the sample placement units 104.

Furthermore, the sprayers 108 arranged corresponding to the respective positions of the sample placement units 104 can each be formed to include two spray ports. With this configuration, the spray state for the entire region of the samples 131 can be made more uniform. Furthermore, the sprayer 108 can spray warm water. By warm water being sprayed in this manner, a decrease in temperature of the samples 131 irradiated with light can be further suppressed.

On the basis of a measurement result of the black panel thermometer 105 and a measurement result of the in-tank thermometer 107, the controller 109 controls the temperature of the surfaces of the samples placed on the sample placement units 104 such that the measurement result of the in-tank thermometer 107 is a set sample temperature. For example, the controller 109 controls the heater 102 to control the temperature of the surfaces of the samples. The test device further includes a blower 110 that generates an air flow inside the thermostatic tank 101.

The test device further includes a humidifier 113 and a hygrometer 114. The controller 109 controls the humidifier 113 on the basis of a measurement result of the hygrometer 114 such that the temperature in the thermostatic tank 101 is set to a set humidity. Furthermore, the controller 109 controls the operation of the rotation mechanism of the rotary sample stage 103 such that the rotation rate of the rotary sample stage 103 is a set value. The controller 109 also controls the operation of the blower 110. Furthermore, the controller 109 can store each measurement result in a storage device (not illustrated) and display each measurement result on a display device (not illustrated) arranged outside the thermostatic tank 101.

Furthermore, this test device can include a spouting device (not illustrated) that spouts water toward the samples 131 placed on the sample placement units 104 of the rotary sample stage 103. The spouting device spouts water with droplets larger in size than mist droplets sprayed by the sprayer 108. The spouting device can also be referred to as another sprayer that sprays with mist droplets larger in size than mist droplets sprayed by the sprayer 108. In order to simulate the influence of rainfall (for example, washing away low molecular weight components on the surfaces of the samples, and the like) in an actual outdoor environment, additionally spraying water having a large droplet size of water sprayed to the samples 131 is desirable. Therefore, using the above-described spouting device in addition to the sprayer 108 is desirable.

For example, the size of a droplet formed on an object (surface of the black panel thermometer 105) by the spouting device can be 100 μm to 1 mm. Warm water can also be used in the spouting device. By warm water being used, a decrease in temperature of the samples 131 can be suppressed.

By this test device being used, an accelerated weathering test can be performed by the following method. First, the samples 131 are placed on a plurality of the respective sample placement units 104 of the rotary sample stage 103 that is arranged inside the thermostatic tank 101 for performing a weathering test, has a cylindrical shape, includes the plurality of sample placement units 104 on the inner surface of the cylinder, and rotates around the cylinder (first step). Next, the samples are irradiated with light for a weathering test (second step). Further, the sprayer 108 sprays water to the samples 131 placed on the sample placement units 104 of the rotary sample stage 103 and the black panel thermometer 105 (third step). At this time, water simulating rain or the like can also be supplied by a spouting device.

Next, the temperature in the thermostatic tank 101 is controlled so as to be a set temperature on the basis of a measurement result by the black panel thermometer 105 arranged on the inner surface of the cylinder of the rotary sample stage 103 and a measurement result of the temperature in the thermostatic tank 101 (fourth step). Furthermore, the humidifier 113 is controlled on the basis of a measurement result of the hygrometer 114 such that the temperature in the thermostatic tank 101 is set to a set humidity. The temperature state, the humidity state, the light irradiation, and the water spraying set as described above are continued for a set time.

In this way, a decrease in temperature of the samples 131 irradiated with light can be suppressed even in a state where water is attached.

According to the test device according to the embodiment, water is sprayed by the sprayer 108 in a test for accelerating degradation by light, so that a test for accelerating a degradation reaction that progresses in the coexistence of water and light can be performed.

Hereinafter, experimental results will be described. First, samples were prepared by a urethane resin coating being applied by a thickness of 50 μm to steel materials of 7 cm*15 cm. This coating test piece is a coating that was subjected to a separate outdoor exposure test and caused chalk in one year of exposure period.

A test condition 1 is a test based on “JIS K 5600-7-7-A”, and is a test in which “step A1: light irradiation intensity 60 W/m² (wavelength 300 nm-400 nm), black panel temperature 63° C., in-tank temperature 38° C., in-tank humidity 50% RH, no water spray, treatment time T1=102 min” and “step B1: light irradiation intensity 60 W/m² (wavelength 300 nm-400 nm), in-tank temperature 38° C., treatment time T2 using a spouting device=18 minutes” are repeated. In the test condition 1, the sprayer 108 was not used but the spouting device was used in step B1. The urethane resin coating used as a sample caused chalk in one year in an actual outdoor environment, but on the other hand, in the test condition 1, chalk was not confirmed even when the test was performed for 2000 hours, which is considered to correspond to three to four years in the outdoor environment, and it was found that outdoor deterioration could not be reproduced.

In a test condition 2, following each step of the test condition was repeated and performed for 2000 hours.

Step A2: light irradiation intensity 60 W/m² (wavelength 300 nm-400 nm), black panel temperature 63° C., in-tank temperature 38° C., in-tank humidity 50% RH, no water spray, treatment time T1=60 minutes.

Step B2: light irradiation intensity 60 W/m² (wavelength 300 nm-400 nm), in-tank temperature 38° C., treatment time T2 using the spouting device=60 minutes. The spouting device has a nozzle diameter of a nozzle for spraying of 0.5 mm.

In the test condition 2, although water was supplied for the test condition 1, chalk could not be reproduced even when the test was performed for 2000 hours. It can be said that it has become clear that chalk cannot be reproduced only by the ratio of the time for supplying water being increased. This is considered to be because the temperature of the surfaces of the samples was decreased and the rate of the degradation reaction in a state where the surfaces of the samples were wet was decreased in a case of only spraying room temperature water of large-sized droplets (mist droplets) to the surfaces of the samples.

In a test condition 3, following each step of the test condition was repeated and performed for 2000 hours.

Step A3: light irradiation intensity 60 W/m² (wavelength 300 nm-400 nm), black panel temperature 63° C., in-tank temperature 38° C., in-tank humidity 50% RH, no water spray, T1=60 minutes.

Step C3: light irradiation intensity 60 W/m² (wavelength 300 nm-400 nm), in-tank temperature 38° C., treatment time T3 using the sprayer 108=60 minutes. The sprayer 108 has a nozzle diameter of a nozzle for spraying of 0.3 mm.

In the test condition 3, chalk of the samples was confirmed at the time when the test was performed for 1000 hours. It is considered that a decrease in temperature on the surfaces of the samples can be reduced by mist of small size mist droplets being sprayed to the surfaces of the samples, and the reaction rate of the degradation reaction that progresses in the coexistence of light and water can be increased as compared with the test condition 2. It can be said that the effect of improving the reproduction accuracy of outdoor deterioration by the size of mist droplets of the sprayed mist being reduced was confirmed.

In a test condition 4, following each step of the test condition was repeated and performed.

Step A4: light irradiation intensity 60 W/m² (wavelength 300 nm-400 nm), black panel temperature 63° C., in-tank temperature 38° C., in-tank humidity 50% RH, no water spray, T1=42 minutes.

Step B4: light irradiation intensity 60 W/m² (wavelength 300 nm-400 nm), in-tank temperature 38° C., treatment time T2 using the spouting device=18 minutes.

Step C4: light irradiation intensity 60 W/m² (wavelength 300 nm-400 nm), in-tank temperature 38° C., treatment time T3 using the sprayer 108=60 minutes.

In the test condition 4, chalk occurred at the time when the test was performed for 750 hours. This is considered to be because in the test condition 3, outflow of low molecular weight components and the like caused by rainfall in an actual outdoor environment could not be reproduced due to a small size of sprayed droplets, but in the test condition 4, the test time required for reproducing chalk could be shortened by step B4 of supplying water in the form of droplets being added to the test condition 3.

In the test condition 4, when the particle diameters of mist water and droplet-shaped water attached to the black panel thermometer 105 installed on a sample placement unit 104 were measured, many of the former were several μm to several tens of μm, and many of the latter were several hundreds of μm. It is considered that the size of droplets attached to the black panel thermometer 105 installed on the sample placement unit 104 is suitably 100 μm to 1 mm in the form of a droplet, and 1 μm to 99 μm in the form of a mist.

Furthermore, it is considered that, in a case where the sprayer 108 is installed closer to the sample placement units 104, mist sprayed from each of the spray ports to a corresponding sample does not reach the samples 131 of the sample placement units 104 at different positions and water is uniformly sprayed to each of the samples, and accordingly, the distance between each of the spray ports and a corresponding sample placement unit 104 is preferably within 10 cm. In order to uniformly spray water to the samples, two or more spray ports of the sprayer 108 are desirably included for each height of the corresponding sample placement units 104.

Next, a test condition 5 will be described. In the same test cycle as in the test condition 4, warm water was sprayed from the sprayer 108, and warm water was supplied from the spouting device. In the test condition 5 performed under this condition, chalk occurred in 500 hours. It is considered that a decrease in temperature of the surfaces of the samples could be further prevented using warm water, and the test time could be shortened as compared with the test condition 4.

The results of each experiment described above are indicated in Table 1 below.

TABLE 1

| Test | | | | Performance | | |
|---|---|---|---|---|---|---|
| condition No. | T1 | T2 | T3 | time | Chalk | Note |
| 1 | 102 | 18 | 0 | 2000 | No | |
| 2 | 60 | 60 | 0 | 2000 | No | |
| 3 | 60 | 0 | 60 | 1000 | Yes | |
| 4 | 42 | 18 | 60 | 750 | Yes | |
| 5 | 42 | 18 | 60 | 500 | Yes | Warm water was |
| | | | | | | sprayed from |
| | | | | | | sprayer 108 and |
| | | | | | | spouting device |

Although a device capable of performing a weathering test includes a water spray unit for spraying salt water in order to evaluate weathering and corrosion resistance in a combined manner, the sprayer 108 does not spray salt water but sprays water such as pure water.

As described above, according to embodiments of the present invention, mist droplets of mist sprayed by a sprayer that sprays water to samples are set in a range in which a decrease in temperature of the samples irradiated with light is suppressed by spraying to the samples, so that a test for accelerating a degradation reaction that progresses in the coexistence of water and light can be performed.

In a test using a conventional test device, it is considered that stretching of a time for supplying water is effective for reproducing deterioration that progresses only in the coexistence of water and light, but the inventors have found by experiments that a sufficient effect cannot be obtained by stretching of a water spraying time in the conventional test device, and considered that the cause is a decrease in a deterioration reaction rate due to a decrease in temperature of samples during water spraying.

In an accelerated weathering test, in order to simulate the influence of sunshine and rainfall in an actual environment, a test method of supplying water in the form of droplets is widely used, and conceiving an idea of implementing wetting of the surfaces of samples while preventing a decrease in temperature of the surface layers of the samples by spraying mist water in the form of smaller mist droplets as in embodiments of the present invention is not easy.

Furthermore, in the accelerated weathering test device, reducing variation in results depending on the installation position of the sample holder is important. The sprayer is brought close to the sample placement units, focusing on the fact that mist sprayed toward the upper portion of the rotary sample holder reaches samples in the lower portion of the rotary sample holder, which may cause variation in the wetting degree of samples depending on the installation position of the sample holder.

According to embodiments of the present invention, thin water films can be formed on the surfaces of samples without the temperature of the surfaces of the samples being significantly lowered, and a degradation reaction that occurs only in the coexistence of light and water can be reproduced. Specifically, resin decomposition by photocatalytic action of titanium dioxide contained as a pigment in coatings or plastics can be reproduced, and a deterioration phenomenon such as chalk that cannot be reproduced by a conventional accelerated weathering test can be reproduced. By deterioration that occurs in an actual outdoor environment being able to be reproduced by an accelerated weathering test, material performance can be accurately evaluated in a short period of time without an outdoor exposure test being performed.

Note that embodiments of the present invention are not limited to the embodiment described above, and it is obvious that many modifications and combinations can be made by those skilled in the art within the technical idea of the present invention.

### REFERENCE SIGNS LIST

101 Thermostatic tank
102 Heater
103 Rotary sample stage
104 Sample placement unit
105 Black panel thermometer
106 Light source
107 In-tank thermometer
108 Sprayer
109 Controller
110 Blower
111 Radiometer
112 Light source control unit
113 Humidifier
114 Hygrometer
131 Sample

1-8. (canceled)

9. A test device comprising:
a thermostatic tank;
a heater configured to heat air inside the thermostatic tank;
a humidifier configured to humidify the air inside the thermostatic tank;
a rotary sample stage arranged inside the thermostatic tank, wherein the rotary sample stage comprises a cylinder with a sample placement frame disposed on an inner surface thereof, the sample placement frame being configured to receive a sample to be tested placed thereon;
a black panel thermometer arranged on the inner surface of the cylinder;
a light source arranged at a rotation center of the rotary sample stage and configured to irradiate the black panel thermometer and the sample placed on the sample placement frame with light for a weathering test, wherein the rotary sample stage is configured to rotate around the light source;
an in-tank thermometer configured to measure a temperature in the thermostatic tank;
a hygrometer configured to measure humidity in the thermostatic tank;
a sprayer configured to spray water to the sample placed on the sample placement frame, wherein sizes of mist droplets of a mist of the water sprayed by the sprayer are set in a predetermined range to suppress a decrease in a temperature of the sample irradiated with the light by spraying the water to the sample; and
a controller configured to control the temperature in the thermostatic tank based on a measurement result of the black panel thermometer and a measurement result of the in-tank thermometer such that the measurement result of the in-tank thermometer is a set sample temperature.

10. The test device according to claim 9, wherein the range of the sizes of the mist droplets deposited on the sample by spraying of the sprayer is 1 μm to 99 μm.

11. The test device according to claim 9, wherein the sprayer comprises a nozzle having a nozzle diameter of 0.3 mm.

12. The test device according to claim 9, further comprising a spouting device configured to spout additional water toward the sample placed on the sample placement frame.

13. The test device according to claim 12, wherein the additional water spouted by the spouting device is warm water.

14. The test device according to claim 9, wherein the water sprayed by the sprayer is warm water.

15. A test device comprising:
a thermostatic tank;
a heater configured to heat air inside the thermostatic tank;
a humidifier configured to humidify the air inside the thermostatic tank;
a rotary sample stage arranged inside the thermostatic tank, wherein the rotary sample stage comprises a cylinder with a plurality of sample placement frames disposed on an inner surface thereof, the sample placement frames being configured to receive samples to be tested placed thereon;
a black panel thermometer arranged on the inner surface of the cylinder;
a light source arranged at a rotation center of the rotary sample stage and configured to irradiate the black panel thermometer and the samples placed on the sample placement frames with light for a weathering test, wherein the rotary sample stage is configured to rotate around the light source;
an in-tank thermometer configured to measure a temperature in the thermostatic tank;
a hygrometer configured to measure humidity in the thermostatic tank;
a plurality of sprayers configured to spray water to the samples placed on the sample placement frames, wherein the sprayers are positioned in accordance with placement positions of the sample placement frames, wherein a maximum distance between a spray port of each of the sprayers and the corresponding sample placement frame is 10 cm, and wherein sizes of mist droplets of a mist of the water sprayed by the sprayer are set in a predetermined range to suppress a decrease in a temperature of the samples irradiated with the light by spraying the water to the samples; and
a controller configured to control the temperature in the thermostatic tank based on a measurement result of the black panel thermometer and a measurement result of the in-tank thermometer such that the measurement result of the in-tank thermometer is a set sample temperature.

16. The test device according to claim 15, wherein the sprayers each include two spray ports.

17. The test device according to claim 15, wherein the water sprayed by the sprayers is warm water.

18. The test device according to claim 15, wherein the range of the sizes of the mist droplets deposited on the samples by spraying of the sprayer is 1 μm to 99 μm.

19. A method for arranging a test device for performing a weathering test, the method comprising:
providing a thermostatic tank;
disposing a heater inside the thermostatic tank to heat air inside the thermostatic tank;
disposing a humidifier inside the thermostatic tank to humidify the air inside the thermostatic tank;
arranging a rotary sample stage inside the thermostatic tank, wherein the rotary sample stage comprises a cylinder with a plurality of sample placement frames disposed on an inner surface thereof;
placing a sample to be tested on a first sample placement frame of the plurality of sample placement frames;
arranging a black panel thermometer on a second sample placement frame of the plurality of sample placement frames;
arranging a light source at a rotation center of the rotary sample stage to irradiate the black panel thermometer and the sample with light for the weathering test, wherein the rotary sample stage rotates around the light source during the weathering test;
disposing an in-tank thermometer inside the thermostatic tank to measure a temperature in the thermostatic tank;
disposing a hygrometer inside the thermostatic tank to measure humidity in the thermostatic tank;
disposing a sprayer inside the thermostatic tank to spray the sample with water, wherein sizes of mist droplets of a mist of the water sprayed by the sprayer are set in a predetermined range to suppress a decrease in a temperature of the sample irradiated with the light by spraying the water to the sample; and
providing a controller to control the temperature in the thermostatic tank based on a measurement result of the black panel thermometer and a measurement result of the in-tank thermometer such that the measurement result of the in-tank thermometer is a set sample temperature.

20. The method according to claim 19, wherein the range of the sizes of the mist droplets deposited on the sample by spraying of the sprayer is 1 μm to 99 μm.

21. The method according to claim 19, wherein the sprayer comprises a nozzle having a nozzle diameter of 0.3 mm.

22. The method according to claim 19, further comprising disposing a spouting device inside the thermostatic tank to spout additional water toward the sample placed on the sample placement frame.

23. The method according to claim 22, wherein the additional water spouted by the spouting device is warm water.

24. The method according to claim 19, wherein the water sprayed by the sprayer is warm water.
